(19) United States
(12) Patent Application Publication
(10) Pub. No.: US 2026/0358683 A1
(43) Pub. Date: Nov. 12, 2026

(54) LENS BARREL AND IMAGING DEVICE EQUIPPED WITH SAME

(71) Applicant: Panasonic Intellectual Property Management Co., Ltd., Osaka (JP)

(72) Inventors: Atsushi HASEGAWA, Osaka (JP); Manabu KOBAYASHI, Osaka (JP)

(73) Assignee: Panasonic Intellectual Property Management Co., Ltd., Osaka (JP)

(21) Appl. No.: 19/667,729

(22) Filed: May 5, 2026

(30) Foreign Application Priority Data
May 9, 2025 (JP) 2025-078442

(51) Int. Cl. G03B 17/14

(52) U.S. Cl. CPC G03B 17/14

(57) ABSTRACT

A lens barrel 10 includes a lens L1, a lens holding frame 11a, and an annular lens hold-down plate 11c. The lens holding frame 11a holds the lens L1 and has a substantially cylindrical flange 11ab, an annular threaded portion 11ba to which an optical filter is attached, and an engagement portion 11bb that is disposed on the flange 11ab on the opposite side from the subject in the optical axis AX direction with respect to the threaded portion 11ba and that protrudes beyond the threaded portion 11ba in the radial inward direction centered on the optical axis AX from the inner peripheral surface of the flange 11ab. The annular lens hold-down plate 11c is attached on the inner peripheral surface side of the flange 11ab so as to make contact with the lens L1 from the subject side in the optical axis AX direction, and has an engagement portion 11cb that protrudes radially outward and engages with the engagement portion 11bb.

### CROSS-REFERENCE TO RELATED APPLICATIONS

This application claims priority to Japanese Patent Application No. 2025-078442 filed on May 9, 2025. The entire disclosure of Japanese Patent Application No. 2025-078442 is hereby incorporated herein by reference.

### BACKGROUND

### Technical Field

The present disclosure relates to a lens barrel, and to an imaging device equipped with this lens barrel.

### Description of the Related Art

For example, Patent Literature 1 discloses a lens barrel including a first lens holding frame that holds a first lens, a first guide shaft that guides the first lens holding frame in the optical axis direction, a contact member that comes into contact with the first guide shaft, and a biasing member that comes into contact with the first lens holding frame and biases the contact member toward the first guide shaft, in order to provide a lens barrel with good optical performance.

### CITATION LIST

### Patent Literature

Patent Literature 1: WO 2022/124364 A

### SUMMARY

### Problem to be Solved by the Invention

However, the following problem is encountered with the above-mentioned conventional lens barrel.

With the lens barrel disclosed in the above publication, in order to hold the first lens group disposed closest to the subject side, a lens hold-down member for stably holding the heavy first lens group, a filter screw member for allowing the attachment of an optical filter, etc., are attached on the subject side of the first lens frame.

A problem with this configuration is that more parts are needed, the configuration ends up being more complicated.

It is an object of the present disclosure to provide a lens barrel with which the number of parts can be reduced by simplifying the configuration of the lens holding frame that holds the first lens group and to which an optical filter is attached, as well as an imaging device equipped with this lens barrel.

### Means for Solving Problem

The lens barrel according to the present disclosure includes a first lens group, a lens holding frame, and an annular lens hold-down member. The first lens group is disposed closest to the subject side in the optical axis direction. The lens holding frame holds the first lens group and has a substantially cylindrical first main body portion, an annular threaded portion that is provided to the inner peripheral surface of the first main body portion on the subject side in the optical axis direction and to which an optical filter is attached, and a first engagement portion that is disposed on the first main body portion on the opposite side from the subject in the optical axis direction with respect to the threaded portion and that protrudes beyond the threaded portion from the inner peripheral surface of the first main body portion in the inner radial direction centered on the optical axis. The annular lens hold-down member is attached on the inner peripheral surface side of the first main body portion of the lens holding frame so as to come into contact with the first lens group from the subject side in the optical axis direction, and has a second engagement portion protruding in outward in the radial direction and engaging with the first engagement portion.

### Effects

With the lens barrel according to the present disclosure, the configuration of the lens holding frame that holds the first lens group and to which the optical filter is attached can be simpler, and this means fewer parts are necessary.

### BRIEF DESCRIPTION OF THE DRAWINGS

FIG. 1 is an overall oblique view of the state in which the lens barrel according to an embodiment of the present disclosure has been removably attached to a camera body;

FIG. 2 is an oblique view of the configuration of the lens barrel in FIG. 1;

FIG. 3 is an exploded oblique view of the configuration of the lens barrel in FIG. 1;

FIG. 4 is an oblique view of the configuration of the first lens group unit included in the lens barrel in FIG. 3;

FIG. 5 is an exploded oblique view of the configuration of the first lens group unit in FIG. 4;

FIG. 6 is a cross-sectional view of the first lens group unit in FIG. 4;

FIG. 7 is a detail cross-sectional view of the A portion in FIG. 6;

FIG. 8A is a view of the lens holding frame included in the first lens group unit in FIG. 4, as viewed from the subject side in the optical axis direction;

FIG. 8B is a cross-sectional view along the B-B line in FIG. 8A;

FIG. 9A is a view of the lens hold-down plate included in the first lens group unit in FIG. 4, as viewed from the subject side in the optical axis direction;

FIG. 9B is a projection view of FIG. 9A, as seen from the bottom side in the drawing;

FIG. 10 is an oblique view of the configuration of the decoration ring included in the first lens group unit in FIG. 4;

FIG. 11A is an oblique view showing the state when the lens hold-down plate has been mounted to the lens holding frame, before the decoration ring in FIG. 10 has been attached; and

FIG. 11B is a detail view of the position where an adhesive agent is injected in a state in which the lens hold-down plate has been attached to the lens holding frame in FIG. 11A.

### DETAILED DESCRIPTION OF THE EMBODIMENT

Embodiments will now be described through reference to the drawings. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### Embodiment 1

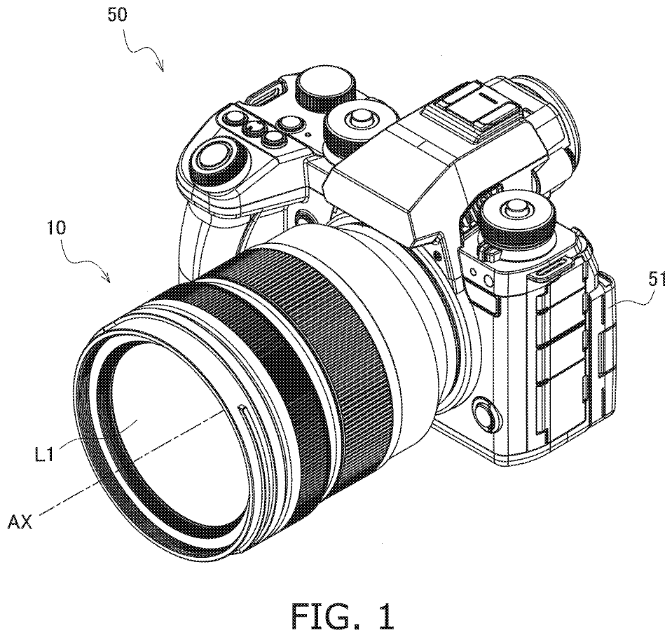

The lens barrel 10 according to an embodiment of the present disclosure and a camera (imaging device) 50 equipped with this lens barrel will now be described with reference to FIGS. 1 to 11B.

### (1) Configuration of Camera 50

As shown in FIG. 1, the camera (imaging device) 50 according to this embodiment includes the lens barrel 10 and a camera body 51.

The lens barrel 10 is removably attached to the camera body 51. The detailed configuration of the lens barrel 10 will be described below.

The camera body 51 captures an image of a subject through the lens barrel 10 with an imaging element (not shown) mounted inside, and thereby produces image data.

### (2) Overall Configuration of Lens Barrel 10

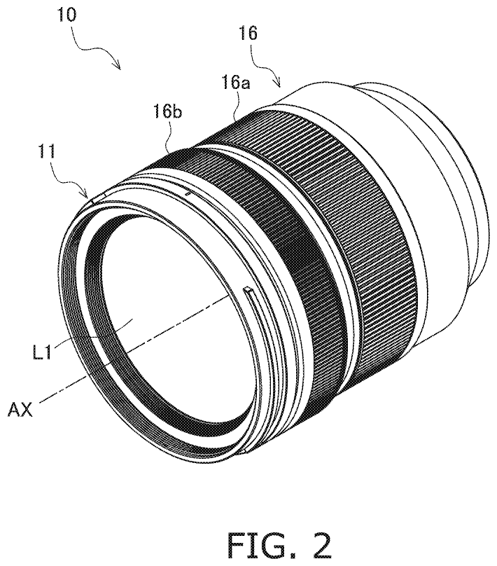

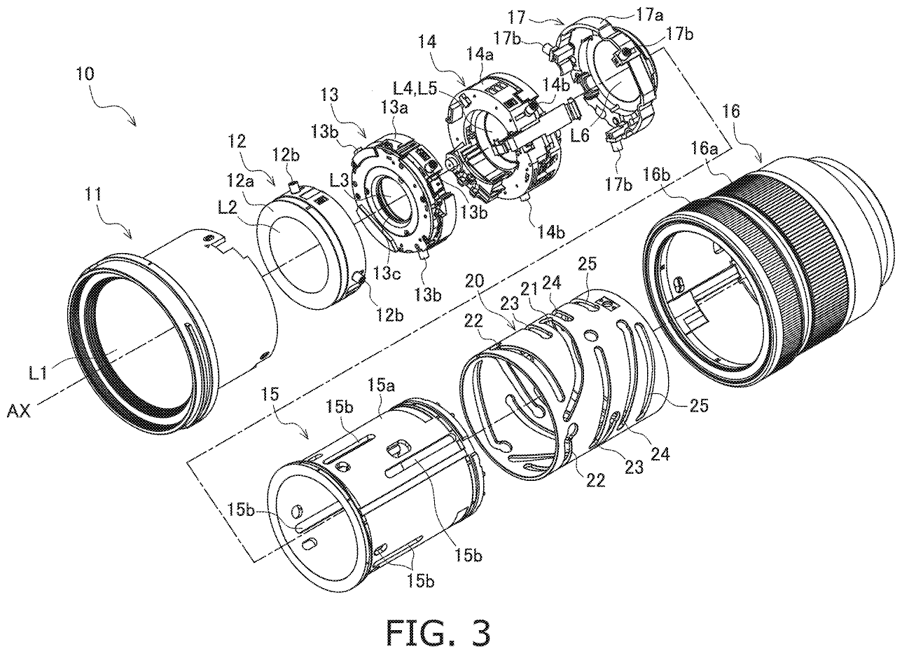

The lens barrel 10 according to this embodiment is removably attached to the camera body 51. As shown in FIGS. 2 and 3, the lens barrel 10 includes a first lens group unit 11, a second lens group unit 12, a third lens group unit 13, a fourth-fifth lens group unit 14, a sixth lens group unit 17, a rectilinear guide barrel 15, a cam barrel 20, and an exterior unit 16.

As shown in FIGS. 2 and 3, the first lens group unit 11 is a substantially cylindrical member that is disposed the closest to the subject in the optical axis AX direction out of all the components constituting the lens barrel 10, and holds a lens (first lens group) L1 on its inner peripheral surface side. The first lens group unit 11 has a cam follower (not shown) that moves in a state of being engaged with a cam groove 21 of a cam barrel 20 (discussed below), and is moved back and forth in the optical axis AX direction as the cam barrel 20 rotates relative to a rectilinear guide barrel 15.

The detailed configuration of the first lens group unit 11 will be described below. As shown in FIG. 3, the second lens group unit (second lens frame) 12 holds a lens L2, and moves back and forth in the optical axis AX direction on the inner peripheral surface side of the rectilinear guide barrel 15 as the cam barrel 20 rotates relative to the rectilinear guide barrel 15. The second lens group unit 12 has a substantially cylindrical main body portion 12a and cam followers 12b that protrude outward in the radial direction around the optical axis AX.

Three cam followers 12b are disposed at approximately equal angular intervals (about 120 degrees) on the outer peripheral surface of the substantially cylindrical main body portion 12a. The cam followers 12b move in a state of being engaged with cam grooves 22 of the cam barrel 20 (discussed below), which moves the second lens group unit 12 back and forth in the optical axis AX direction as the cam barrel 20 rotates relative to the rectilinear guide barrel 15.

As shown in FIG. 3, the third lens group unit 13 holds a lens L3, and has a substantially cylindrical main body portion 13a, cam followers 13b, and an aperture unit 13c.

Three cam followers 13b are disposed at approximately equal angular intervals (about 120 degrees) on the outer peripheral surface of the substantially cylindrical main body portion 13a. The cam followers 13b move in a state of being engaged with cam grooves 23 of the cam barrel 20 (discussed below), which moves the third lens group unit 13 back and forth in the optical axis AX direction as the cam barrel 20 rotates relative to the rectilinear guide barrel 15.

The aperture unit 13c is disposed on the subject side of the main body portion 13a in the optical axis AX direction, and adjusts the amount of light incident from the subject side that passes through the lens barrel 10 by opening and closing aperture blades (not shown) to change the opening surface area.

The fourth-fifth lens group unit (first lens frame) 14 is a linear focus unit that adjusts the focal length by moving the fourth-fifth lens L4, L5 such a focus lens or other contained therein back and forth in the optical axis AX direction when, for example, a focus ring 16b rotatably attached to the outer peripheral surface of the exterior unit 16 is turned. As shown in FIG. 3, the fourth-fifth lens group unit 14 holds lenses L4 and L5, and has a substantially cylindrical main body portion 14a and cam followers 14b.

Three cam followers 14b are disposed at approximately equal angular intervals (about 120 degrees) on the outer peripheral surface of the substantially cylindrical main body portion 14a. The cam followers 14b move in a state of being engaged with the cam grooves 24 of the cam barrel 20 (discussed below), which moves the fourth-fifth lens group unit 14 back and forth in the optical axis AX direction as the cam barrel 20 rotates relative to the rectilinear guide barrel 15.

As shown in FIG. 3, the sixth lens group unit 17 holds a lens L6 and moves back and forth in the optical axis AX direction on the inner peripheral surface side of the rectilinear guide barrel 15 as the cam barrel 20 rotates relative to the rectilinear guide barrel 15. The sixth lens group unit 17 has a substantially cylindrical main body portion 17a and cam followers 17b that protrude outward in the radial direction around the optical axis AX.

Three cam followers 17b are disposed at approximately equal angular intervals (about 120 degrees) on the outer peripheral surface of the substantially cylindrical main body portion 17a. The cam followers 17b move in a state of being engaged with the cam grooves 25 of the cam barrel 20 (discussed below), which moves the sixth lens group unit 17 back and forth in the optical axis AX direction as the cam barrel 20 rotates relative to the rectilinear guide barrel 15.

As shown in FIG. 3, the rectilinear guide barrel 15 is a substantially cylindrical member that is disposed adjacent to the inner peripheral surface side of the cam barrel 20, and the second lens group unit 12, third lens group unit 13, the fourth-fifth lens group unit 14, and the sixth lens group unit 17 are disposed on the inner peripheral surface thereof. The rectilinear guide barrel 15 has a substantially cylindrical main body portion 15a and rectilinear grooves 15b.

The rectilinear grooves 15b are through-grooves formed along the optical axis AX direction, and the cam followers 12b, 13b, and 14b provided to the second lens group unit 12, the third lens group unit 13, the fourth-fifth lens group unit 14, and the sixth lens group unit 17, etc., move in a state of being engaged with these grooves.

The cam barrel 20 is, for example, a substantially cylindrical member formed from aluminum, and as shown in FIG. 3, is disposed on the outer peripheral surface side of the rectilinear guide barrel 15 and drives the second lens group unit 12, the third lens group unit 13, the fourth-fifth lens group unit 14, and the sixth lens group unit 17 back and forth in the optical axis AX direction by rotating relative to the rectilinear guide barrel 15. As shown in FIG. 3, the cam barrel 20 has a substantially cylindrical main body portion 20a and a plurality of cam grooves 21, 22, 23, 24, and 25 formed in the main body portion 20a.

The cam barrel 20 is configured such that the cam grooves 21, 22, 23, 24, and 25 are formed on a substantially cylindrical aluminum member by cutting process.

As shown in FIGS. 2 and 3, the exterior unit 16 is a substantially cylindrical member that constitutes the exterior portion of the lens barrel 10, and has a circular zoom ring 16a, a focus ring 16b, etc., attached to its outer peripheral surface so as to be rotatable in the circumferential direction.

As shown in FIGS. 2 and 3, zoom ring 16a is a substantially annular member provided near the approximate center of exterior unit 16 in the optical axis AX direction, and is turned to move lens barrel 10 from its WIDE position to its TELE position. As the zoom ring 16a rotates, the cam barrel 20 also rotates, causing first lens group unit 11, the second lens group unit 12, the third lens group unit 13, and the fourth-fifth lens group unit 14 and so on to move back and forth in the optical axis AX direction.

As shown in FIGS. 2 and 3, the focus ring 16b is a substantially annular member provided on the outer peripheral surface of the exterior unit 16 at a position adjacent to the subject side of the zoom ring 16a in the optical axis AX direction, and varies the position of the focus lens (lens L4, L5) in the optical axis AX direction. By the rotation of the cam barrel 20 as the focus ring 16b is turned, the fourth-fifth lens group unit 14 moves back and forth in the optical axis AX direction.

### (3) Configuration of First Lens Group Unit 11

With the lens barrel 10 of this embodiment, as shown in FIG. 3, the first lens group unit 11 is disposed closest to the subject side in the optical axis AX direction.

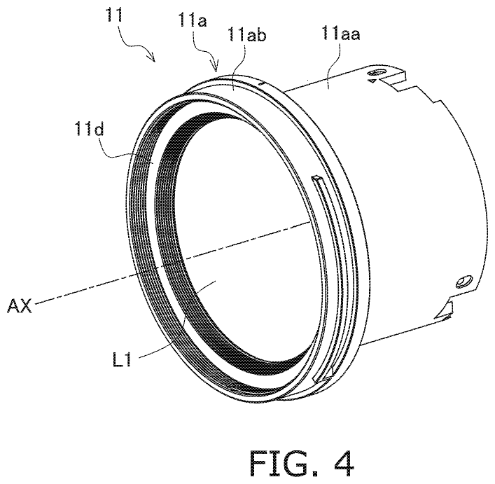

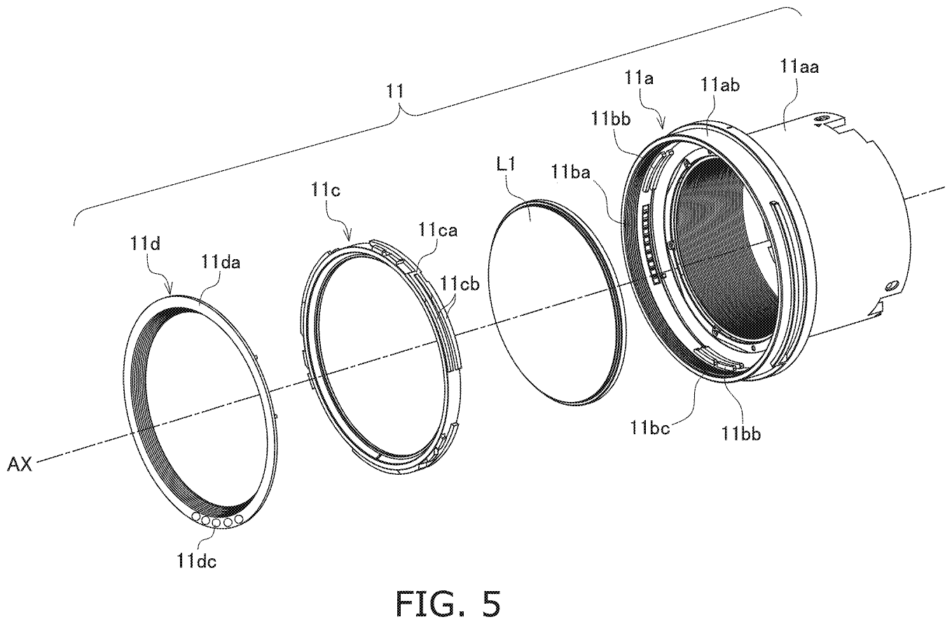

As shown in FIGS. 4 and 5, the first lens group unit 11 includes a lens (first lens group) L1, a lens holding frame 11a, a lens hold-down plate (lens hold-down member) 11c, and a decoration ring 11d.

The lens holding frame 11a holds the lens L1, and has a substantially cylindrical portion 11aa and a flange (first main body portion) 11ab.

As shown in FIG. 4, the cylindrical portion 11aa is a substantially cylindrical portion provided on the opposite side from the subject in the optical axis AX direction, and surrounds, on its inner peripheral surface side, the second lens group unit 12, the third lens group unit 13, and the fourth-fifth lens group unit 14, which move back and forth in the optical axis AX direction.

The flange (first main body portion) 11ab is a substantially cylindrical portion that holds the lens L1 and is linked to the cylindrical portion 11aa on the subject side in the optical axis AX direction. The inner peripheral surface of the flange 11ab is provided with a threaded portion 11ba to which an optical filter (not shown) is mounted, engagement portions (first engagement portions) 11bb to which a lens hold-down plate 11c is mounted, and recesses (first latching portions) 11bc that are provided to the engagement portions 11bb.

As shown in FIG. 5, the threaded portion 11ba is disposed on the inner peripheral surface of the flange 11ab on the side closest to the subject in the optical axis AX direction, and is provided with an annular thread to which the optical filter (not shown) is attached.

As shown in FIG. 5, the engagement portions (first engagement portions) 11bb are disposed at positions adjacent to the threaded portion 11ba on the flange 11ab, on the opposite side from the subject in the optical axis AX direction. The engagement portions 11bb are provided at three locations on the inner peripheral surface of the flange 11ab at approximately equal angular intervals, so as to protrude from the inner peripheral surface of the flange 11ab beyond the threaded portion 11ba inward in the radial diameter direction centered on the optical axis.

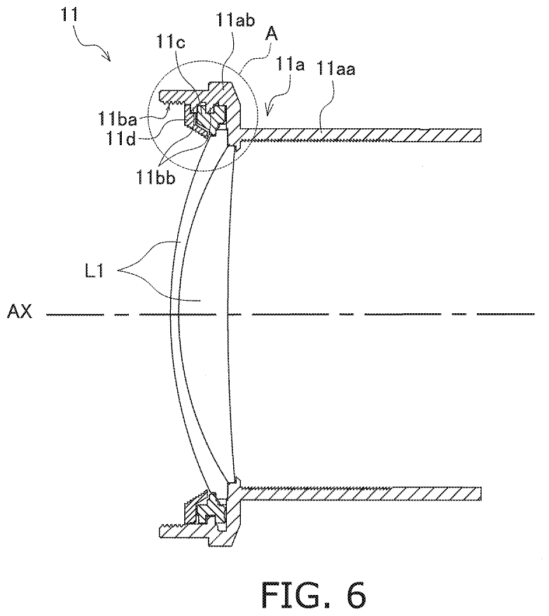

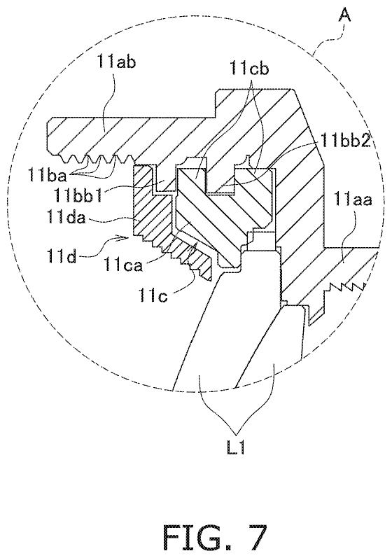

As shown in FIGS. 6 and 7, the threaded portion 11ba and the engagement portions 11bb are disposed on the same inner peripheral surface of the flange 11ab of the lens holding frame 11a. Furthermore, the threaded portion 11ba and the engagement portions 11bb are integrally molded as part of the lens holding frame 11a.

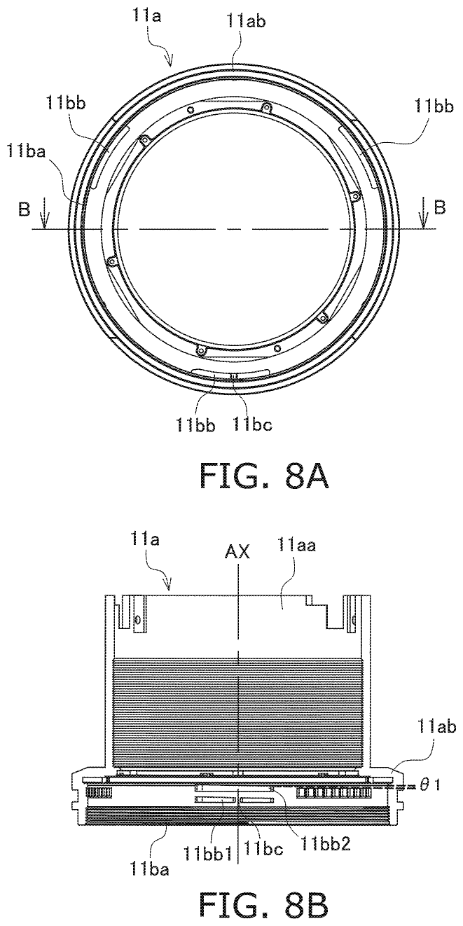

Furthermore, as shown in FIGS. 8A and 8B, the engagement portions 11bb have a convex portion (first convex portion) 11bb1 and a convex portion (second convex portion) 11bb2 formed side by side in the optical axis AX direction on the inner surface of the lens holding frame 11a.

As shown in FIG. 8B, the convex portion (second convex portion) 11bb2 has an inclined surface (inclination θ1) formed at an angle to the circumferential direction of the inner peripheral surface of the lens holding frame 11a, on the surface that engages with the engagement portion 11cb of the lens hold-down plate 11c.

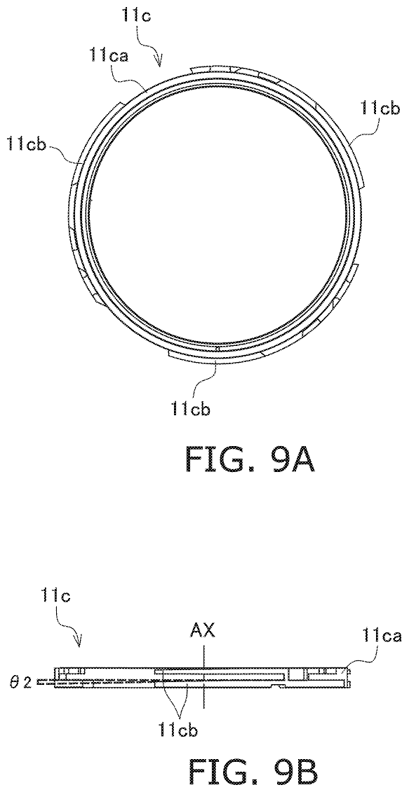

When mounting the lens hold-down plate 11c to the lens holding frame 11a, in a state in which the engagement portions 11bb provided to the lens holding frame 11a shown in FIG. 8A are aligned with the recesses where the engagement portions 11cb of the lens hold-down plate 11c shown in FIG. 9A are not provided, the lens hold-down plate 11c is fitted into the lens holding frame 11a from the subject side in the optical axis AX direction and rotated in the circumferential direction.

At this point, the engagement portions 11cb of the lens hold-down plate 11c move along the inclined surface of the engagement portions 11bb (convex portions 11bb1) of the lens holding frame 11a.

As shown in FIG. 7, the convex portions 11bb2 come into snug contact with the engagement portions 11cb on the image plane side of the lens hold-down plate 11c in the optical axis AX direction, so that the lens hold-down plate 11c is in contact with the lens L1, and the lens L1 is held without any looseness, regardless of variance in the thickness of the lens L1.

As shown in FIG. 7, the engagement portions 11cb on the subject side of the lens hold-down plate 11c are disposed with a gap between them and the convex portions 11bb1, which are provided as reinforcement to prevent the lens hold-down plate 11c from coming off in the event of an impact or the like.

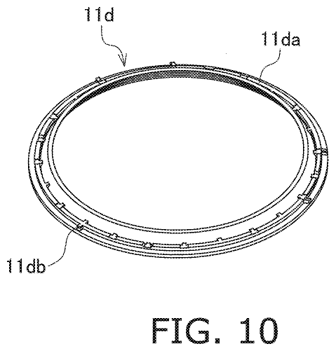

The recesses (first latching portions) 11bc are grooves provided in the optical axis AX direction on the engagement portions 11bb provided on the inner peripheral surface of the flange 11ab, and engage with the protrusion (second latching portion) 11d (see FIG. 10) provided on the decoration ring 11d side (discussed below).

As shown in FIG. 5, the lens hold-down plate (lens hold-down member) 11c is a substantially annular member for holding the lens L1 included in the first lens group unit 11 between itself and the subject-side surface of the flange 11ab. As shown in FIG. 6, the lens hold-down plate 11c makes contact with the lens L1 from the subject-side in the optical axis AX direction. The lens hold-down plate 11c is attached on the inner peripheral surface side of the flange 11ab of the lens holding frame 11a. The lens hold-down plate 11c has a substantially annular main body portion 11ca and engagement portions (second engagement portions) 11cb.

The engagement portions (second engagement portions) 11cb protrude outward in the radial direction from the outer peripheral surface of the substantially annular main body portion 11ca, and engage with the engagement portions 11bb on the lens holding frame 11a side. As discussed above, the engagement portions 11cb are fitted into the lens holding frame 11a from the subject side in the optical axis AX direction in a state of being aligned with the recesses of the lens hold-down plate 11c shown in FIG. 9A where the engagement portions 11cb are not provided, and the lens hold-down plate 11c is turned in the circumferential direction to move the engagement portions 11cb to a position overlapping the engagement portions 11bb when viewed in the optical axis AX direction.

As a result, movement of the lens hold-down plate 11c is restricted in the optical axis AX direction, and the lens hold-down plate 11c is fixed to the lens holding frame 11a by bayonet coupling.

The engagement portions 11cb are inserted between the engagement portions 11bb (the convex portions (first convex portions) 11bb1 and the convex portions (second convex portions) 11bb2 shown in FIGS. 8A and 8B ) provided to the lens holding frame 11a. As shown in FIGS. 9A and 9B, the engagement portion 11cb has an inclined surface (inclination θ2) formed obliquely with respect to the circumferential direction of the outer peripheral surface of the lens hold-down plate 11c, on the surface that makes contact with the convex portions 11bb1 or the convex portions 11bb2.

Consequently, it is easier for the engagement portions 11cb to be inserted between the engagement portions 11bb (convex portions 11bb1 and 11bb2) of the lens holding frame 11a when the lens hold-down plate 11c is mounted to the lens holding frame 11a.

As shown in FIG. 5, the decoration ring 11d is a substantially annular member that is attached to the lens holding frame 11a on the subject side in the optical axis AX direction. As shown in FIG. 10, the decoration ring 11d has a substantially annular main body portion (second main body portion) 11da, a convex portion (second latching portion) 11db, and a specification display portion 11dc (see FIG. 5).

The substantially annular main body portion 11da has a specification display portion 11dc formed on the surface on the subject side in the optical axis AX direction, and a convex portion 11db formed on the surface on the opposite side from the subject.

The convex portion (second latching portion) 11db is formed along the optical axis AX direction on the surface of the substantially annular main body portion 11da on the side that is mounted to the lens holding frame 11a, and engages with the concave portion 11bc.

The specification display portion 11dc indicates various specifications of the lens barrel 10, such as the focal length, maximum aperture F-number, and filter diameter.

Here, in a state in which the convex portion 11db of the decoration ring 11 d has been latched to the concave portion 11bc of the lens holding frame 11a, the rotation of the decoration ring 11d is restricted, which means that the orientation of the decoration ring 11d is set.

This allows the orientation of the decoration ring 11d to be set so that the wording indicating the specifications of the lens barrel 10 and the like are easy to read when the camera 50 is in its normal orientation.

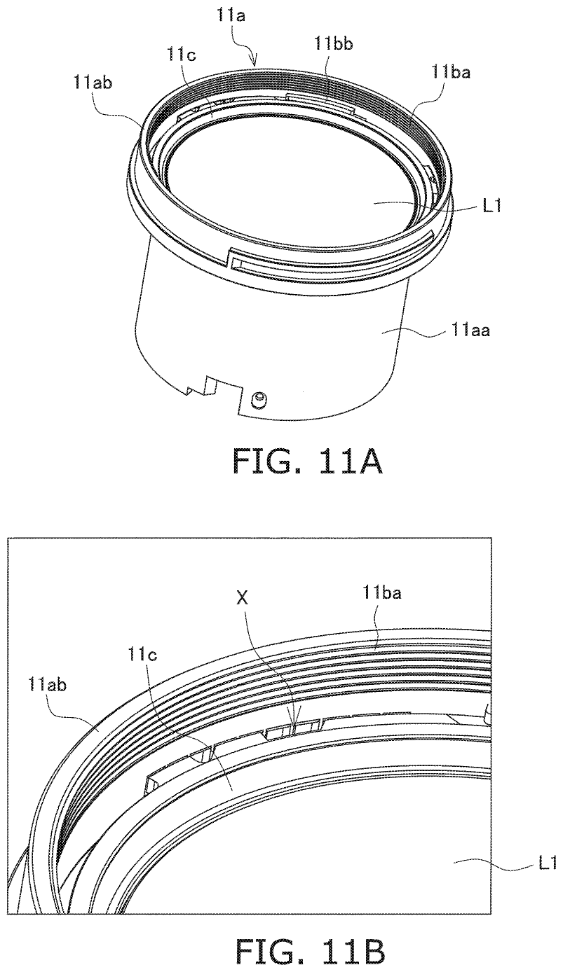

Also, as shown in FIG. 11A, the decoration ring 11d is attached after the lens hold-down plate 11c has been mounted to the lens holding frame 11a and an adhesive injected at the adhesive injection position X shown in FIG. 11B.

The adhesive injection position X is provided in the gap between the outer peripheral surface of the substantially annular lens hold-down plate 11c and the inner peripheral surface of the flange 11ab.

Consequently, the adhesive can fix the lens hold-down plate 11c in the rotation direction around the optical axis AX, and fix the decoration ring 11d.

### Main Features

As shown in FIG. 7, the lens barrel 10 of this embodiment includes the lens L1, the lens holding frame 11a, and the annular lens hold-down plate 11c. The lens L1 is disposed closest to the subject side in the optical axis AX direction. The lens holding frame 11a holds the lens L1 and has the substantially cylindrical flange 11ab, the annular threaded portion 11ba that is provided on the inner peripheral surface of the flange 11ab on the subject side in the optical axis AX direction and to which an optical filter is attached, and the engagement portions 11bb that are disposed on the opposite side from the subject in the optical axis AX direction on the flange 11ab with respect to the threaded portion 11ba, and that protrude inward in the radial direction centered on the optical axis AX beyond the threaded portion 11ba from the inner peripheral surface of the flange 11ab. The annular lens hold-down plate 11c is attached on the inner peripheral surface side of the flange 11ab of the lens holding frame 11a so as to make contact with the lens L1 from the subject side in the optical axis AX direction, and has the engagement portions 11cb that protrude outward in the radial direction and engage with the engagement portions 11bb.

Consequently, the threaded portion 11ba to which the optical filter is attached and the engagement portions 11bb to which the lens hold-down plate 11c that holds the lens L1 is attached are integrally formed on the lens holding frame 11a, which simplifies the configuration of the first lens group unit 11.

As a result, the configuration of the first lens group unit 11 is simplified and fewer parts are required.

### Other Embodiments

An embodiment of the present disclosure was described above, but the present disclosure is not limited to or by the above embodiment, and various modifications are possible without departing from the gist of the disclosure.

### (A)

In the above embodiment, an example was given in which the engagement portions 11bb provided on the inner peripheral surface of the lens holding frame 11a and the engagement portions 11cb provided on the outer peripheral surface of the lens hold-down plate 11c attached to the inner peripheral surface of the lens holding frame 11a were fixed by bayonet connection. However, the present disclosure is not limited to this.

For example, the method by which the lens hold-down member is fixed to the lens holding frame is not limited to bayonet coupling, and some other fixing method, such as screw fastening, may be used instead.

### (B)

In the above embodiment, an example was given in which the rotation of the decoration ring 11d around the optical axis AX was restricted by inserting the convex portion 11db provided on the decoration ring 11d into the concave portion 11bc provided on the lens holding frame 11a of the first lens group unit 11. However, the present disclosure is not limited to this.

For example, a combination may be used in which the first latching portion provided on the decoration ring side is a concave portion, and the second latching portion provided on the lens holding frame side is a convex portion.

### (C)

In the above embodiment, an example was given in which the decoration ring 11d was fixed to the lens holding frame 11a to which the lens hold-down plate 11c was attached by an adhesive injected at the adhesive injection position X. However, the present disclosure is not limited to this.

For example, the configuration may be such that the decoration ring is fixed by forming an engaged relationship with the lens holding frame side or the lens hold-down member.

### (D)

In the above embodiment, an example was given in which various specifications, such as the focal length, maximum aperture F-number, and filter diameter of the lens barrel 10, were indicated on the specification display portion 11dc of the decoration ring 11d. However, the present disclosure is not limited to this.

For example, the specifications display portion of the decoration ring may be configured to indicate other information, such as the lens configuration, maximum magnification, maximum shooting distance, weight, size, and product name.

### (E)

In the above embodiment, an example was given in which the configuration of the present disclosure was applied to the lens barrel 10 that was detachably attached to the camera body 51. However, the present disclosure is not limited to this.

For example, the configuration of the present disclosure may be applied to a lens barrel that is fixed non-removably to a camera body.

### Addenda

The above description of the embodiments discloses the following techniques.

### Technique 1:

The lens barrel according to Technique 1 comprises:
a first lens group that is disposed closest to the subject side in the optical axis direction;
a lens holding frame that holds the first lens group and has a substantially cylindrical first main body portion, an annular threaded portion that is provided on the inner peripheral surface of the first main body portion on the subject side in the optical axis direction and to which an optical filter is attached, and a first engagement portion that is disposed on the first main body portion on the opposite side from the subject in the optical axis direction with respect to the threaded portion and that protrudes beyond the threaded portion from the inner peripheral surface of the first main body portion in the inner radial direction centered on the optical axis; and
an annular lens hold-down member that is attached to the inner peripheral surface side of the first main body portion of the lens holding frame so as to make contact with the first lens group from the subject side in the optical axis direction, and that has a second engagement portion that protrudes outward in the radial direction and engages with the first engagement portion.

### Technique 2:

The lens barrel according to Technique 2 is the lens barrel according to Technique 1,
wherein the threaded portion and the first engagement portion are disposed on the same inner peripheral surface of the first main body portion of the lens holding frame.

### Technique 3:

The lens barrel according to Technique 3 is the lens barrel according to Technique 1 or 2,
wherein the threaded portion and the first engagement portion are formed integrally.

### Technique 4:

The lens barrel according to Technique 4 is the lens barrel according to any of Techniques 1 to 3,
wherein the lens holding frame has a first latching portion that is provided along the optical axis direction on the inner peripheral surface of the first main body portion.

### Technique 5:

The lens barrel according to Technique 5 is the lens barrel according to Technique 4,further comprising a decoration ring that has a substantially annular second main body portion, and a second latching portion formed along the optical axis direction on the surface of the second main body portion on the side where the lens holding frame is attached, and engaging with the first latching portion, and that is attached to the lens holding frame on the subject side in the optical axis direction.

### Technique 6:

The lens barrel according to Technique 6 is the lens barrel according to Technique 4,wherein the first latching portion is provided to the first engagement portion.

### Technique 7:

The lens barrel according to Technique 7 is the lens barrel according to Technique 5, wherein in a state in which the first latching portion and the second latching portion are latched, the orientation of the decoration ring is determined.

### Technique 8:

The lens barrel according to Technique 8 is the lens barrel according to Technique 7,wherein the decoration ring further has a specifications display portion that displays the specifications of the lens barrel and is provided on the surface on the subject side in the optical axis direction.

### Technique 9:

The lens barrel according to Technique 9 is the lens barrel according to any of Techniques 1 to 8,
wherein the first engagement portion has a first convex portion and a second convex portion formed side by side in the optical axis direction on the inner peripheral surface of the lens holding frame, and
the first convex portion has an inclined surface formed obliquely with respect to the circumferential direction of the inner peripheral surface of the lens holding frame, on the surface of the lens hold-down member that engages with the second engagement portion.

### Technique 10:

The lens barrel according to Technique 10 is the lens barrel according to Technique 9, wherein the second engagement portion of the lens hold-down member is inserted between the first convex portion and the second convex portion.

Technique 11:

The lens barrel according to Technique 11 is the lens barrel according to Technique 10,
wherein the second engagement portion has an inclined surface formed obliquely with respect to the circumferential direction of the outer peripheral surface of the lens hold-down member, on the surface that makes contact with the first convex portion or the second convex portion.

### Technique 12:

The lens barrel according to Technique 12 is the lens barrel according to any of Techniques 1 to 11,
wherein the first engagement portion engages the lens holding frame with the lens hold-down member by bayonet coupling.

### Technique 13:

The imaging device according to Technique 13 comprises:
the lens barrel according to any of Techniques 1 to 12; and
a camera body to which the lens barrel is attached.

### INDUSTRIAL APPLICABILITY

The lens barrel of the present disclosure exhibits the effect that the configuration of a lens holding frame to which an optical filter is attached and which holds a first lens group can be simpler, and as such is widely applicable to various kinds of lens barrel that is attached to an imaging device.

### REFERENCE SIGNS LIST

10 lens barrel
11 first lens group unit
11a lens holding frame
11aa cylindrical portion
11ab flange (first main body portion)
11ba threaded portion
11bb engagement portion (first engagement portion)
11bb1 convex portion (first convex portion)
11bb2 convex portion (second convex portion)
11bc recess (first latching portion)
11c lens hold-down plate (lens hold-down member)
11ca main body portion
11cb engagement portion (second engagement portion)
11d decoration ring
11da main body portion (second main body portion)
11db convex portion (second latching portion)
11dc specification display portion
12 second lens group unit
12a main body portion
12b cam follower
13 third lens group unit
13a main body portion
13b cam follower
13c aperture unit
14 fourth-fifth lens group unit
14a main body portion
14b cam follower
15 rectilinear guide barrel
15a main body portion
15b rectilinear groove
16 exterior unit
16a zoom ring
16b focus ring
17 sixth lens group unit
17a main body portion
17b cam follower
20 cam barrel
20a main body portion
21, 22, 23, 24, 25 cam grooves
50 camera (imaging device)
51 camera body
AX optical axis
L1 lens (first lens group)
L2 to L5 lenses
X adhesive injection position
θ1, θ2 inclination

1. A lens barrel, comprising:
a first lens group that is disposed closest to a subject side in an optical axis direction;
a lens holding frame that holds the first lens group and has a substantially cylindrical first main body portion, an annular threaded portion that is provided on an inner peripheral surface of the first main body portion on the subject side in the optical axis direction and to which an optical filter is attached, and a first engagement portion that is disposed on the first main body portion on an opposite side from a subject in the optical axis direction with respect to the threaded portion and that protrudes beyond the threaded portion from the inner peripheral surface of the first main body portion in an inner radial direction centered on the optical axis; and
an annular lens hold-down member that is attached to an inner peripheral surface side of the first main body portion of the lens holding frame so as to make contact with the first lens group from the subject side in the optical axis direction, and that has a second engagement portion that protrudes outward in a radial direction and engages with the first engagement portion.

2. The lens barrel according to claim 1,
wherein the threaded portion and the first engagement portion are disposed on the same inner peripheral surface of the first main body portion of the lens holding frame.

3. The lens barrel according to claim 1,
wherein the threaded portion and the first engagement portion are formed integrally.

4. The lens barrel according to claim 1,
wherein the lens holding frame has a first latching portion that is provided along the optical axis direction on the inner peripheral surface of the first main body portion.

5. The lens barrel according to claim 4,
further comprising a decoration ring that has a substantially annular second main body portion, and a second latching portion formed along the optical axis direction on a surface of the second main body portion on a side where the lens holding frame is attached, and engaging with the first latching portion, and that is attached to the lens holding frame on the subject side in the optical axis direction.

6. The lens barrel according to claim 4,
wherein the first latching portion is provided to the first engagement portion.

7. The lens barrel according to claim 5,
wherein in a state in which the first latching portion and the second latching portion are latched, an orientation of the decoration ring is determined.

8. The lens barrel according to claim 7,
wherein the decoration ring further has a specifications display portion that displays the specifications of the lens barrel and is provided on the surface on the subject side in the optical axis direction.

9. The lens barrel according to claim 1,
wherein the first engagement portion has a first convex portion and a second convex portion formed side by side in the optical axis direction on the inner peripheral surface of the lens holding frame, and
the first convex portion has an inclined surface formed obliquely with respect to a circumferential direction of the inner peripheral surface of the lens holding frame, on the surface of the lens hold-down member that engages with the second engagement portion.

10. The lens barrel according to claim 9,
wherein the second engagement portion of the lens hold-down member is inserted between the first convex portion and the second convex portion.

11. The lens barrel according to claim 10,
wherein the second engagement portion has an inclined surface formed obliquely with respect to the circumferential direction of an outer peripheral surface of the lens hold-down member, on the surface that makes contact with the first convex portion or the second convex portion.

12. The lens barrel according to claim 1,
wherein the first engagement portion engages the lens holding frame with the lens hold-down member by bayonet coupling.

13. An imaging device, comprising:
the lens barrel according to claim 1; and
a camera body to which the lens barrel is attached.
